(19) United States
(12) Patent Application Publication
(10) Pub. No.: US 2004/0135929 A1
(43) Pub. Date: Jul. 15, 2004

(54) Digital broadcasting receiving apparatus, receiving method and receiving circuit

(75) Inventors: Isao Hoda, Fujisawa (JP); Hitoshi Akiyama, Yokohama (JP); Tatsuo Nagata, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/626,047

(22) Filed: Jul. 23, 2003

(30) Foreign Application Priority Data
Nov. 27, 2002 (JP) 2002-343177

(51) Int. Cl. H04N 5/50

(52) U.S. Cl. 348/732; 725/38

(57) ABSTRACT

The present invention is directed to a method and an apparatus for storing the digital broadcasting channels in the channel list including those for which the receiving environment is not stable as well as those for which the receiving environment is stable. In one embodiment, a digital broadcasting receiving apparatus for receiving a broadcasting signal comprises a tuner unit configured to extract a signal of a desired physical channel from an input signal, and a first judging unit configured to judge whether or not the signal extracted by the tuner unit includes a digital broadcasting signal. A program information obtaining unit is configured to extract the program information included in the digital broadcasting signal from the signal extracted by the tuner unit and processed by the first judging unit, if the program information included in the digital broadcasting signal can be extracted, when it is judged in the first judging unit that the signal extracted by the tuner unit includes the digital broadcasting signal. A memory unit is configured to store a judgment result in the first judging unit and the program information of the digital broadcasting signal obtained by the program information obtaining unit.

### CROSS-REFERENCES TO RELATED APPLICATIONS

This application relates to and claims priority from Japanese Patent Application Number 2002-343177, filed on Nov. 27, 2002.

### BACKGROUND OF THE INVENTION

1. Field of the Invention

This invention relates to a receiving apparatus which is used for receiving a wireless signal or a wired signal of a digital broadcasting, and in particular, relates to a digital broadcasting receiving apparatus and a receiving method in which effective digital channels are stored in a channel list.

2. Description of the Related Art

An analog broadcasting receiving apparatus and a digital broadcasting receiving apparatus store information relating to channels which can be received as channel list data, for example, in a non-volatile memory unit. At the time that a power supply of the receiving apparatus is turned on for the first time, the channel information is not included in this channel list data. Therefore, in case that a user of the receiving apparatus, for example, issues an order for changing channels in ascending order, regardless of presence or absence of a broadcasting signal of each channel, all channels are selected in ascending order, and therefore, it becomes difficult to realize a quick station selection operation. Then, there is a necessity to store channel information of channels which can be received by a unit of some kind.

As a way for storing the channel information of effective digital broadcasting channels, by carrying out a scan of all channels, the digital broadcasting channels are identified, and by storing skip-flag data of the identified each channel by a memory unit, it becomes possible for a user to select stations of only effective channels (see, e.g., U.S. Pat. No. 6,137,546, at pages 5-8 and FIG. 1).

Also, there is such an example that, in case that a received signal is of quality above a certain level, as candidates of channels which can be received, a preliminary scan processing is carried out for preliminary registration in a memory device, and thereafter, main scan processing is carried out for applying the station selection operation to each candidate sequentially (see, e.g., US2002/0097344A1, at pages 2-4 and FIG. 7).

In case that the digital broadcasting modulated by a digital modulation system is transmitted, digital broadcasting channels of all channels are identified in advance, and a channel list of effective digital broadcasting channels including virtual channel number and program number or the like is prepared, and thereby, it becomes possible to realize a quick station selection operation for a short period of time. However, in case of a terrestrial broadcasting, it may be impossible to maintain a stable receiving condition which is necessary for obtaining the channel information at the time of channel scan. At this time, there is such a problem that it is not possible to store information of the digital broadcasting channels which are not continuously stable as the virtual channel in the channel list, unless the program information such as the virtual channel number and the program number or the like can be extracted, even if there are channels which are actually broadcasted.

### SUMMARY OF THE INVENTION

The present invention is directed to a method and a digital broadcasting receiving apparatus for storing the digital broadcasting channels in the channel list including those for which the receiving environment is not stable as well as those for which the receiving environment is stable. The channels are available to the user for updating.

In accordance with an aspect of the present invention, a digital broadcasting receiving apparatus for receiving a broadcasting signal comprises a tuner unit configured to extract a signal of a desired physical channel from an input signal, and a first judging unit configured to judge whether or not the signal extracted by the tuner unit includes a digital broadcasting signal. A program information obtaining unit is configured to extract the program information included in the digital broadcasting signal from the signal extracted by the tuner unit and processed by the first judging unit, if the program information included in the digital broadcasting signal can be extracted, when it is judged in the first judging unit that the signal extracted by the tuner unit includes the digital broadcasting signal. A memory unit is configured to store a judgment result in the first judging unit and the program information of the digital broadcasting signal obtained by the program information obtaining unit.

In some embodiments, a second judging unit is configured to judge whether or not program information included in the digital broadcasting signal can be extracted, when it is judged in the first judging unit that the signal extracted by the tuner unit includes the digital broadcasting signal. The tuner unit is configured to extract signals of a plurality of physical channels which are classified into a first classification and a second classification: (1) a physical channel being in the first classification if the signal of the physical channel is judged in the first judging unit to include a digital broadcasting signal and which is judged in the second judging unit that the program information included in the digital broadcasting signal can be extracted therefrom; and (2) a physical channel being in the second classification if the signal of the physical channel is judged in the first judging unit to include a digital broadcasting signal and which is judged in the second judging unit that the program information included in the digital broadcasting signal cannot be extracted therefrom. The first and second classifications of physical channels are stored in the memory unit.

In accordance with another aspect of the invention, a receiving apparatus for receiving a broadcasting signal comprises a tuner unit configured to extract a signal of a desired frequency from a broadcasting signal which includes a plurality of frequencies and one or more programs at each of the plurality of frequencies, and a program information obtaining unit configured to obtain program information which identifies the program included in the signal that is extracted in the tuner unit. An output unit is configured to output a signal representing channel information which can be selected for broadcasting. The channel information includes first information which represents that, without identifying the program included in the frequency extracted, the frequency is available, and second information which represents that, by identifying the program included in the frequency on the basis of the program information obtained in the program information obtaining unit, the frequency is available. The first information and the second information are information corresponding to different frequencies of the broadcasting signal, respectively.

Another aspect of this invention is directed to a digital broadcasting receiving method in which channel information of a digital broadcasting is scanned by channel scan and stored. The method comprises selecting a physical channel from a signal received; judging whether or not the selected physical channel includes a digital broadcasting signal; judging whether or not program information included in the digital broadcasting signal can be obtained, in case that it is judged that the digital broadcasting signal is included; and storing in a memory unit that the physical channel includes the digital broadcasting signal, when it is judged that the selected physical channel includes the digital broadcasting signal but the program information included in the digital broadcasting signal cannot be obtained.

In accordance with another aspect of the invention, a receiving circuit for receiving a digital broadcasting signal comprises an input unit to which a signal of a selected physical channel is inputted; a first judging unit configured to judge whether or not the signal which is inputted by the input unit includes the digital broadcasting signal; and a second judging unit configured to judge whether or not program information included in the digital broadcasting signal can be extracted, when it is judged in the first judging unit that the inputted signal includes the digital broadcasting signal. A program information obtaining unit is configured to extract program information included in the inputted digital broadcasting signal. A memory unit is configured to store a judgment result in the first judging unit, and to store the program information of the digital broadcasting signal which is obtained by the program information obtaining unit if it is judged in the second judging unit that the program information which is included in the digital broadcasting signal can be extracted.

Yet another aspect of the invention is directed to a digital broadcasting receiving method in which channel information of a digital broadcasting is scanned by channel scan. The method comprises scanning a signal to preset one or more physical channels; displaying that a physical channel includes a digital broadcasting signal if the physical channel includes a digital broadcasting signal but the program information included in the digital broadcasting signal cannot be obtained; and displaying channel information of a physical channel, if the physical channel includes a digital broadcasting signal and the program information included in the digital broadcasting signal can be obtained.

### BRIEF DESCRIPTION OF THE DRAWINGS

The invention, together with further advantages thereof, may best be understood by reference to the following description taken in conjunction with the accompanying drawings in which:

FIG. 1 is a flow chart for illustrating an automatic channel scan function in an embodiment to which the invention was applied;

FIG. 2 is a block diagram showing a structure of a digital broadcasting receiving apparatus having the automatic channel scan function in the embodiment to which the invention was applied;

FIG. 3 is a block diagram for illustrating in detail a demodulation unit of the digital broadcasting receiving apparatus in the embodiment to which the invention was applied;

FIG. 4 is a view showing an example of channel information which is stored in a channel list by the automatic channel scan function in the embodiment to which the invention was applied; and

FIG. 5 is a view showing an example in which the channel information stored in the channel list by the automatic channel scan function is displayed on a display device in the embodiment to which the invention was applied.

### DETAILED DESCRIPTION OF THE INVENTION

A digital broadcasting receiving apparatus, namely, a terrestrial digital broadcasting receiving apparatus in the United States will be described in detail with reference to drawings illustrating embodiments of the invention.

In the United States, a terrestrial digital broadcasting by ATSC (Advanced Television Systems Committee) system has begun, and as a modulation system, 8VSB (Vestigial Side Band) modulation system is adopted. Also, for a brief period of time from the start of the digital broadcasting, there occurs an environment in which digital signals of 8VSB system and analog signals of conventional NTSC (National Television System Committee) system are mixed in a band for use in television broadcasting.

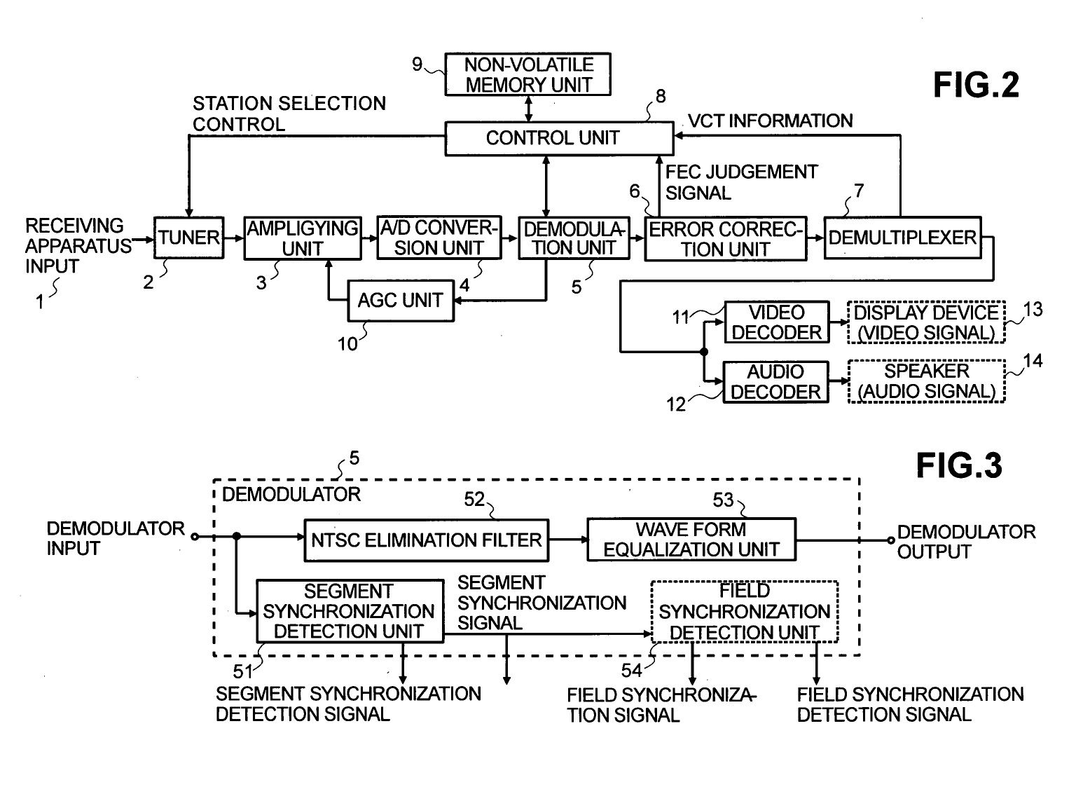

FIG. 2 is a block diagram showing a structure of a digital broadcasting receiving apparatus having an automatic channel scan function in an embodiment to which the invention was applied, and FIG. 3 is a block diagram for illustrating in detail a demodulation unit of the digital broadcasting receiving apparatus in the embodiment to which the invention was applied.

In this digital broadcasting receiving apparatus, for example, the terrestrial digital broadcasting signal (hereinafter, referred to as ATSC signal) or the analog broadcasting signal (hereinafter, referred to as NTSC signal) which was received by a receiving antenna is inputted as a receiving apparatus input 1. The signal which was inputted to the receiving apparatus is supplied to a tuner 2, and a desired physical channel is selected from the signal inputted. Here, the physical channel means a frequency which is allocated to each channel of the terrestrial broadcasting. This station selection operation is controlled by a control unit 8. The signal selected is supplied to an amplifying unit 3, and amplified. The signal amplified by the amplifying unit 3 is supplied to an A/D conversion unit 4, and converted from analog signals to digital signals. In addition, in the embodiment relating to the invention, a position of the A/D conversion unit 4 is not limited to a stage prior to a demodulation unit 5. The signal converted into the digital signal is supplied to the demodulation unit 5, and demodulated by 8VSB modulation system.

The signal supplied to the demodulation unit 5 is supplied not only to a segment synchronization detection unit 51 but also an NTSC elimination filter 52. In the segment synchronization detection unit 51, a segment synchronization signal defined in the ATSC system is detected. The segment synchronization signal detected by the segment synchronization detection unit 51 is supplied to an AGC unit 10. Also, the segment synchronization detection unit supplies the segment synchronization detection signal to a control unit 8. In the control unit 8, a synchronization flag is set from the segment synchronization detection signal. A value of the synchronization flag is made to be “1” in case that the segment synchronization signal was detected, and is made to be “0” in case that the segment synchronization signal was not detected. Therefore, in case that a receiving signal is the ATSC signal, the segment synchronization signal is detected, and the value of the synchronization flag becomes “1”. On the other hand, in case that the receiving signal is the NTSC signal, or in case that the receiving signal is the ATSC signal but a receiving condition is very bad, the segment synchronization signal is not detected, and the value of the synchronization flag becomes “0”.

Also, it is possible to add a field synchronization detection unit 54 to the segment synchronization detection unit 51. In short, it is also possible to supply the segment synchronization signal outputted from the segment synchronization detection unit to the field synchronization detection unit 54, and to supply the field synchronization detection signal to the control unit 8. In the control unit 8, the synchronization flag is set from the field synchronization detection signal. The value of the synchronization flag is made to be “1” in case that the field synchronization signal was detected, and is made to be “0” in case that the field synchronization signal was not detected. A judgment standard of the synchronization flag is not limited to availability or non-availability of the segment synchronization detection or the field synchronization detection. This is the first judging function performed by the control unit 8 of determining whether the signal includes a digital broadcasting signal. The control unit 8 may include a first judging unit to perform the first judging function. The control unit 8 is typically a processor which executes a computer program to perform function including the first judging function. In the exemplary embodiment, the first judging unit judges that the input signal includes the digital broadcasting signal when a predetermined synchronization signal is detected in the signal being demodulated in the demodulating unit 5.

Also, in the AGC unit 10, AGC voltage is controlled on the basis of the segment synchronization signal and supplied to the amplifying unit 3. Although not shown in FIG. 2, an AGC control voltage value which is controlled by the AGC unit 10 is also supplied to the control unit 8, and when it is known that other signals will not be detected (for example, when signals such as NTSC signals or the like do not exist), it is possible to carry out a judgment of presence or absence of the ATSC signal on the basis of this.

In the NTSC elimination filter 52, among supplied signals, the ATSC signal is a major signal, and in case that a ratio of electric field strength of the NTSC signal and electric field strength of the ATSC signal is smaller than a reference value, the filter is made to be turned ON, and the NTSC signal is eliminated. In case that the ratio of electric field strength of the NTSC signal and electric field strength of the ATSC signal is larger than the reference value, the filter is made to be turned OFF, and the supplied signal is outputted as it is. An output of the NTSC elimination filter 52 passes through a wave form equalization unit 53, and is outputted from the demodulation unit 5.

The signal outputted from the demodulation unit 5 is supplied to an error correction unit 6, and after an error correction is carried out, it is supplied to a demultiplexer 7. In the error correction unit 6, in case that a bit error rate before error correction is more than a preset reference value, an FEC (Forward Error Correction) judgment signal is made to be “0”, and in case that the bit error rate before error correction is less than the pre-set reference value, the FEC judgment signal is made to be “1”, and it is supplied to the control unit 8.

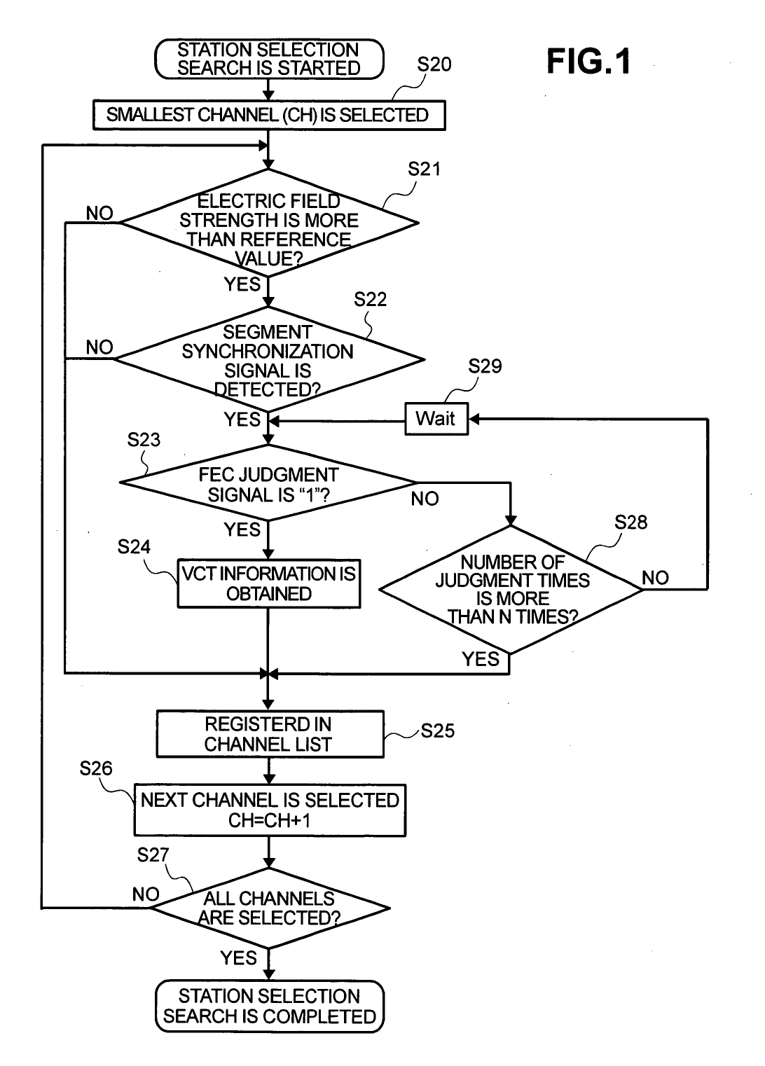

In addition, in the exemplary embodiment of the invention, the judgment standard of the FEC judgment signal is not limited to the bit error rate before error correction. For example, in case that a synchronization signal of MPEG (Motion Picture Experts Group) was detected, the FEC judgment signal is made to be “1”, and in case that the synchronization signal of MPEG was not detected, the FEC judgment signal is made to be “0”, and it is supplied to the control unit 8. This is the second judging function performed by the control unit 8 of whether the program information included in the digital broadcasting signal can be extracted based on a bit error rate which is detected in the error correction unit 6. The control unit 8 may include a second judging unit to perform the second judging function. In the exemplary embodiment, the second judging unit judges whether or not the program information included in the digital broadcasting signal can be extracted based on synchronization establishment of digital data which is outputted from the error correction unit. In some cases, the second judging unit judges whether or not the program information included in the digital broadcasting signal can be extracted based on a result of detecting the bit error rate a plurality of times in the error correction unit 6, as discussed below (see Steps S23-S29 in FIG. 1). As discussed above, the control unit 8 is typically a processor which executes a computer program to perform functions including the first judging function and the second function.

The signals supplied to the demultiplexer 7 are separated into video data, audio data and so on, and the video data is supplied to a video decoder 11 and the audio data is supplied to an audio decoder 12. In the video decoder 11, coded video data is demodulated, and outputted as a video signal. Also, in the audio decoder 12, coded audio data is demodulated, and outputted as an audio signal. The receiving apparatus of the invention, if a display device 13 and a speaker 14 are attached thereto, can be used as a television set. Further, in the demultiplexer 7, VCT (Virtual Channel Table) information included in a transport stream is extracted, and supplied to the control unit 8. The control unit 8 is connected to a non-volatile memory unit 9, and necessary data can be stored therein. In addition, the VCT signal is information of each program included in its physical channel, and includes information such as virtual channel number, modulation system, channel TS-ID (Transport Stream-Identification), program number and so on. Here, the virtual channel number is information which is added to each program by a broadcasting company, and comprises, for example, major channel number using physical channel number, and, for example, minor channel number prepared by numbering programs included in the selected physical channel. Also, the modulation system is 8VSB in case of the United States. The channel TS-ID is ID attached to each MPEG TS, and the program number shows the number of programs included in MPEG TS.

In the receiving apparatus configured as described above, an operation on the occasion of carrying out an automatic channel scan function will be described by use of FIG. 1.

FIG. 1 is a flow chart in an embodiment to which the invention was applied for illustrating the automatic channel scan function in case that the automatic channel scan is carried out as to physical channel arrangement defined in the ground broadcasting in the United States.

Here, a receiving environment in which the ATSC signal exists in the selected physical channel and the VCT information can be obtained is assumed to be a receiving environment 1, and a receiving environment in which the ATSC signal exists in the selected physical channel and the VCT information cannot be obtained is assumed to be a receiving environment 2, and a receiving environment in which the ATSC signal does not exist in the selected physical channel is assumed to be a receiving environment 3. The receiving environment 2 is generated by a very bad environment which is proper to the ground broadcasting, for example, a weak electric field environment in which electric field strength is weak and a multipass environment in which reflection waves exist. Also, for example, there is a case that it takes time for wave form equalization processing in the wave form equalization unit 53 and the VCT information cannot be obtained.

Hereinafter, with reference to FIG. 1, an operation of the automatic channel scan in case that the terrestrial digital broadcasting is received will be described in detail.

Firstly, at Step S20, the control unit 8 sets for example, the smallest physical channel, and controls the tuner 2 so as to select the physical channel. In case of the U.S. terrestrial broadcasting, since a range of effective physical channels is of 2 to 69, firstly, the physical channel 2 is set. Next, at Step S21, the control unit 8 judges AGC voltage value set from the AGC unit 10, and if electric field strength in the band of the selected physical channel is less than the reference value, it is judged that the selected physical channel is in the receiving environment 3, and it proceeds to Step S25 where digital broadcasting flag “0” showing that the ATSC signal does not exist in the selected physical channel is stored in the non-volatile memory unit 9. On the other hand, if the electric field strength in the band of the selected physical channel is more than the reference value, it proceeds to Step S22.

At Step S22, the control unit 8 judges the synchronization detection flag, and in case that the synchronization is detected (in case that the synchronization flag is “1”), it is judged that the 8VSB modulated ATSC signal exists in the selected physical channel (the receiving environment 1 or the receiving environment 2), and it proceeds to Step S23. On the other hand, in case that it is not detected, it is judged that the selected physical channel is in the receiving environment 3, and it proceeds to Step 25 where digital broadcasting flag “0” showing that the ATSC signal does not exist in the selected physical channel is stored in the non-volatile memory unit 9.

At Step S23, the control unit 8 judges the FEC judgment signal, and in case of “1”, TS data is normally outputted from 8VSB demodulation unit 5, i.e., it is judged that the selected physical channel is in the receiving environment 1, and it proceeds to Step S24. On the other hand, in case of “0”, it proceeds to Step S28.

At Step S24, the control unit 8 obtains from the VCT information supplied from the demultiplexer 7 the program information of its physical channel, for example, the virtual channel number, the program number and so on, and it proceeds to Step S26 where digital broadcasting flag “1” showing that the ATSC signal exists in the selected physical channel and the program information obtained at Step S24 are stored in the non-volatile memory unit 9. For reference's sake, in a conventional channel scan method, in case that the VCT information could not be obtained at Step S24, it is assumed that the physical channel cannot be received, and the channel list is prepared as such.

At Step S28, the control unit 8 judges whether the number of judgment times at Step S23 is more than the preset number of times, and in case of less than N times, it proceeds to Step S29. At Step S29, the control unit 8 stops operation for a preset period of time, and it proceeds to Step S23. A loop of Steps S23, S28 and S29 is a loop for repeating the judgment of Step S23 only the preset number of reference times, and one for obtaining the VCT information even in case that it took time for wave form equalization processing in the wave form equalization circuit 53.

At Step S28, in case that it is judged that the number of judgment times at Step S23 is more than N times, the ATSC signal exists in the selected physical channel but the receiving environment is aggravated steadily or temporarily so that normal digital data cannot be received. That is, it is judged to be the receiving environment 2, and it proceeds Step S25 where digital broadcasting flag “1” showing that the ATSC signal exists in the selected physical channel is stored in the non-volatile memory unit 9.

Next, at Step S26, the control unit 8 sets a physical channel of 1 being added to currently selected physical channel, and has the tuner 2 select it, and it proceeds to Step S27. That is, since the physical channel currently selected is 2, physical channel 3 is set and the same control is carried out. In addition, in case that it directly proceeds from Step S22 to Step S25, without carrying out Steps S22, S23, S24, S28 and S29, it quickly proceeds to Step S26, and thereby, channel scan time can be shortened. In the same manner, in case that it directly proceeds from Step S21 to Step S25, execution time of Step S22 is also shortened. In this manner, there is such an advantage that, by carrying out judgment of the receiving environment 3 a plurality of times, unnecessary operation is cut down as many as possible and the channel scan time can be shortened.

At Step S27, the control unit 8 judges whether or not all physical channels defined in the U.S. terrestrial broadcasting have been selected, and if not, it returns to Step S21, and a loop from Step S21 to Step S27 is repeated until all physical channels are selected, and the automatic channel scan is completed.

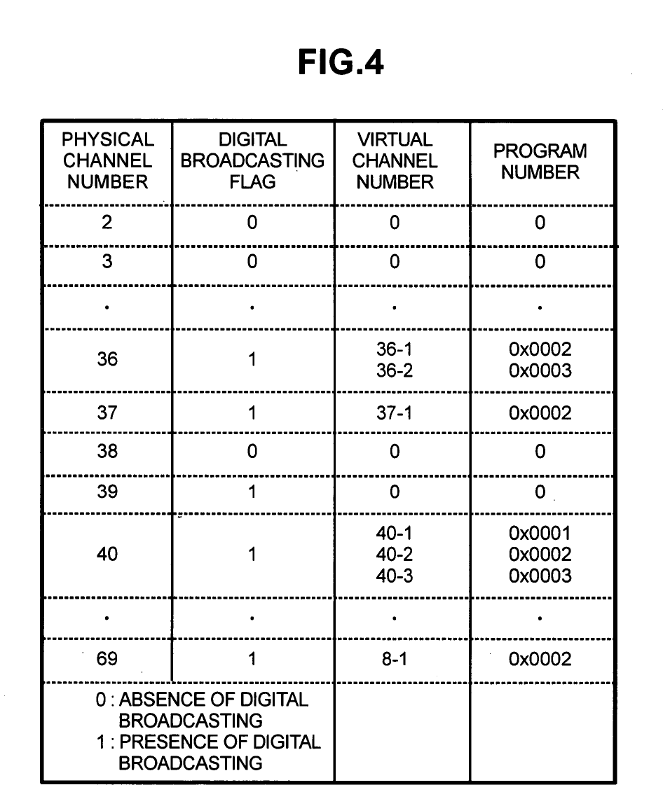

In case that the automatic channel scan function is carried out by the above-described method, an example of the channel list to be stored in the non-volatile memory unit 9 and an operation in case that a user selects the virtual channel in ascending order will be described with reference to FIG. 4.

FIG. 4 is a view showing an example of the channel information stored in the channel list by the automatic channel scan function in the embodiment to which the invention was applied. The physical channel number is a physical channel to be selected by the tuner 2. The digital broadcasting flag is a flag showing that the ATSC signal exists in the selected physical channel, and in case that the ATSC signal exists, becomes “1”. The virtual channel number and the program number are ones which were obtained from the VCT information, and are used for selecting a plurality of programs which exist in one physical channel.

Here, the physical channel number 36, 37, 40, and 69 show that they are in the receiving environment 1, and the physical channel number 39 shows that it is in the receiving environment 2, and the physical channel number 2, 3, and 38 show that they are in the receiving environment 3.

In case that a user carried out the station selection operation, if the digital broadcasting flag is 0, since it is in the receiving environment 3, i.e., it is clear that the ATSC signal does not exist, its station selection operation is neglected by the control unit 8. Also, if the digital broadcasting flag is 1 and the virtual channel number is not 0, since it is in the receiving environment 1, i.e., the ATSC signal which can be received exists clearly, the control unit 8 carries out the station selection by use of this channel information. Further, if the digital broadcasting flag is 1 and the virtual channel number is 0, it shows the receiving environment 2, i.e., a situation that the ATSC signal exists but at the time of the automatic channel scan, the VCT information could not be obtained. In this case, the control unit 8 selects this physical channel, and tries again to obtain the VCT information.

For example, in case that the station selection operation is carried out one time in ascending order, from a situation that the virtual channel number 36-2 is being selected, since the physical channel 37 is in the receiving environment 1, the virtual channel number 37-1 is selected. Next, in case that a user carried out the station selection operation further one more time in ascending order, since one superior physical channel 38 is in the receiving environment 3, it is neglected. Since one more superior physical channel 39 is in the receiving environment 2, the control unit 8 selects the physical channel 39. At this time, if the VCT information can be obtained in the demultiplexer 7, according to the VCT information obtained, the virtual channel number and the program number are rewritten, and it is possible to update the channel list. Here, the case that a user carries out the station selection operation in ascending order was described but, much the same is true on a case that the station selection operation is carried out in descending order.

In the conventional channel scan method, in case that the VCT information could not be obtained at the time of the automatic scan, the physical channel is assumed that it cannot be received. Therefore, the physical channel 38 in the above-described example is considered that it cannot be received, and it is impossible to carry out the station selection in ascending order or in descending order. In contrast to this, according to the invention, even in the physical channel in which the receiving environment is very bad and the VCT information cannot be obtained, by storing such information that the ATSC signal exists, even in case that the VCT information could not be obtained by one time automatic channel scan, it is possible to update the channel list by newly obtaining the VCT information on the occasion of the station selection by a user. On the basis of the updated channel list, it is possible to carry out the channel selection quickly when a user selects a station next time. Further, by disposing a plurality of judgments of existence of the ATSC signal in the selected physical channel, it is possible to shorten time for carrying out the automatic channel scan of all physical channel.

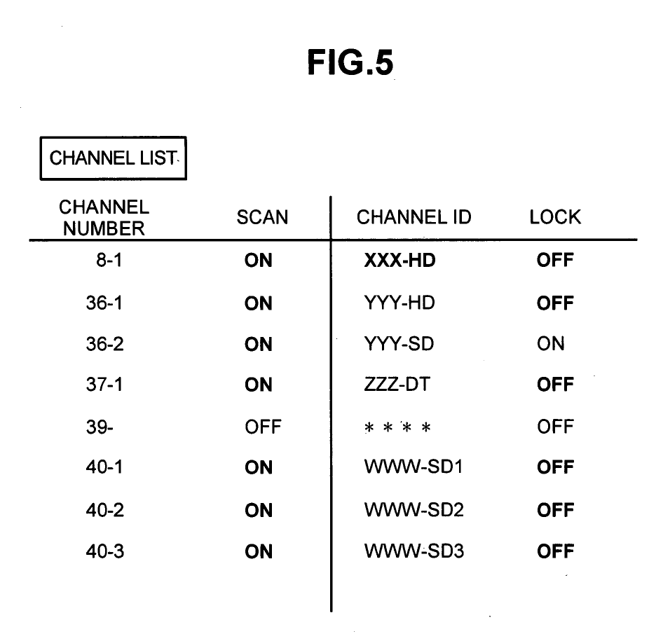

In case that the automatic channel scan function was carried out by the above-described method, the channel list is stored in the non-volatile memory unit 9. Here, a display method on the display device which can be viewed by a user will be described by use of FIG. 5.

FIG. 5 is a view showing an example in which the channel information stored in the channel list by the automatic channel scan function was displayed on the display device in the embodiment to which the invention was applied.

The channel number is the virtual channel number in the example of the above-described channel list. A scan item shows such a function that, in case that a user carries out the station selection operation in ascending order or in descending order, a channel in which this item is OFF is not selected, and only channel number in which it is ON is selected. This item can be freely set by a user. Also, on the occasion of forming the channel list, it may be automatically set to OFF to the physical channel which was judged to be in the receiving environment 2. A channel ID is ID which was determined with respect to each broadcasting company. Lock is an item for setting viewing limitation, and a user can freely set it.

Here, the channel number 8-1, 36-1, 36-2, 37-1, 40-1, 40-2, and 40-3 shows that they are the physical channels of the receiving environment 1, and the channel number 39-shows that it is the physical channel of the receiving environment 2. These channels in environment 1 and environment 2 are preset channels that are stored and available to the user after the scanning procedure indicates that they include digital broadcasting signals. The program information included in the digital broadcasting signals of physical channels in environment 1 can be obtained, while the program information included in the digital broadcasting signals of physical channels in environment 2 cannot be obtained.

In case that the physical channel of the receiving environment 2 was selected, supposed is a case in which the receiving environment is not improved and the video cannot be displayed. As a method by which a user may identify such a channel, in the channel list display, the channel item of the receiving environment 2 is displayed by a small character or inversion or the like.

In addition, in the embodiments relating to the invention, the digital broadcasting signal is not limited to the ATSC signal which is the digital broadcasting standard in the United States but, can be applied to digital broadcasting in countries and broadcasting through a communication line.

The invention can be applied as a dedicated receiving apparatus which is different from the display device etc. and may be built in the display device. Also, it may be built in a memory device such as HDD etc. Further, it may be a tuner board and a receiving circuit (e.g., IC). In particular, in case that it is made to be the receiving circuit, it is possible to use as the receiving circuit to which a signal selected by a tuner part is inputted. By use of the structure of the invention, usability of a user at the time of channel selection is improved.

The above-described arrangements of apparatus and methods are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

What is claimed is:

1. A digital broadcasting receiving apparatus for receiving a broadcasting signal, comprising:
a tuner unit configured to extract a signal of a desired physical channel from an input signal;
a first judging unit configured to judge whether or not the signal extracted by the tuner unit includes a digital broadcasting signal;
a program information obtaining unit configured to extract the program information included in the digital broadcasting signal from the signal extracted by the tuner unit and processed by the first judging unit, if the program information included in the digital broadcasting signal can be extracted, when it is judged in the first judging unit that the signal extracted by the tuner unit includes the digital broadcasting signal; and
a memory unit configured to store a judgment result in the first judging unit and the program information of the digital broadcasting signal obtained by the program information obtaining unit.

2. The digital broadcasting receiving apparatus as set forth in claim 1, further comprising a second judging unit configured to judge whether or not program information included in the digital broadcasting signal can be extracted, when it is judged in the first judging unit that the signal extracted by the tuner unit includes the digital broadcasting signal.

3. The digital broadcasting receiving apparatus as set forth in claim 2, wherein the program information obtaining unit extracts the program information included in the digital broadcasting signal and the memory unit stores the program information of the digital broadcasting signal obtained by the program information obtaining unit, if it is judged in the second judging unit that the program information included in the digital broadcasting signal can be extracted.

4. The digital broadcasting receiving apparatus as set forth in claim 2, wherein the tuner unit is configured to extract signals of a plurality of physical channels which are classified into a first classification and a second classification:
a physical channel being in the first classification if the signal of the physical channel is judged in the first judging unit to include a digital broadcasting signal and which is judged in the second judging unit that the program information included in the digital broadcasting signal can be extracted therefrom;
a physical channel being in the second classification if the signal of the physical channel is judged in the first judging unit to include a digital broadcasting signal and which is judged in the second judging unit that the program information included in the digital broadcasting signal cannot be extracted therefrom; and
wherein the first and second classifications of physical channels are stored in the memory unit.

5. The digital broadcasting receiving apparatus as set forth in claim 4,
wherein the tuner unit is configured to extract signals of a plurality of physical channels which are classified into the first classification, the second classification, and a third classification,
wherein a physical channel is in the third classification if the signal of the physical channel is judged in the first judging unit not to include a digital broadcasting signal; and
wherein the third classification of physical channel is stored in the memory unit.

6. The digital broadcasting receiving apparatus as set forth in claim 4, further comprising an output unit configured to output such a display signal that a channel which is stored in the memory unit and belongs to the first classification and a channel which is stored in the memory unit and belongs to the second classification are separately displayed on a display screen as channels which can be selected, respectively.

7. The digital broadcasting receiving apparatus as set forth in claim 6, wherein the output unit comprises a television.

8. The digital broadcasting receiving apparatus as set forth in claim 2, further comprising an error correction unit configured to carry out an error correction of the input signal, and wherein the second judging unit judges whether or not the program information included in the digital broadcasting signal can be extracted based on a bit error rate which is detected in the error correction unit.

9. The digital broadcasting receiving apparatus as set forth in claim 8, wherein the second judging unit judges whether or not the program information included in the digital broadcasting signal can be extracted based on a result of detecting the bit error rate a plurality of times in the error correction unit.

10. The digital broadcasting receiving apparatus as set forth in claim 2, further comprising an error correction unit configured to carry out an error correction of the input signal, and wherein the second judging unit judges whether or not the program information included in the digital broadcasting signal can be extracted based on synchronization establishment of digital data which is outputted from the error correction unit.

11. The digital broadcasting receiving apparatus as set forth in claim 2, wherein when a physical channel selected from the memory unit has a signal which was judged in the first judging unit to include the digital broadcasting signal and which was judged in the second judging unit to contain program information that could not be extracted, the program information obtaining unit is configured to newly obtain the program information which is included in the digital broadcasting signal.

12. The digital broadcasting receiving apparatus as set forth in claim 11, wherein when the program information which is included in the digital broadcasting signal is newly detected, the program information obtained is stored in the memory unit.

13. The digital broadcasting receiving apparatus as set forth in claim 2, further comprising a display device for displaying image information which is included in the signal of the physical channel that is extracted in the tuner unit, and information representing results judged in the first judging unit and the second judging unit.

14. The digital broadcasting receiving apparatus as set forth in claim 1, wherein the program information obtaining unit is disposed downstream of the first judging in a signal processing path for the signal extracted by the tuner unit to extract the program information from the signal which has been processed by the first judging unit in the same signal processing path.

15. The digital broadcasting receiving apparatus as set forth in claim 1, further comprising a demodulating unit configured to demodulate the signal extracted by the tuner unit from the input signal, and wherein the first judging unit judges that the input signal includes the digital broadcasting signal when a predetermined synchronization signal is detected in the signal being demodulated in the demodulating unit.

16. The digital broadcasting receiving apparatus as set forth in claim 15, wherein the predetermined synchronization signal is a segment synchronization signal which is detected by a segment synchronous detecting unit included in the demodulating unit, or a field synchronization signal which is detected by a field synchronous detecting unit included in the demodulating unit.

17. The digital broadcasting receiving apparatus as set forth in claim 1, further comprising an amplifying unit configured to amplify the signal which is inputted, and wherein the first judging unit judges whether or not the digital broadcasting signal is included based on an AGC voltage in the amplifying unit.

18. The digital broadcasting receiving apparatus as set forth in claim 1, wherein the program information which is included in the digital broadcasting signal includes any information of virtual channel number, modulation system, channel TS-ID, and program number.

19. A receiving apparatus for receiving a broadcasting signal comprising:
a tuner unit configured to extract a signal of a desired frequency from a broadcasting signal which includes a plurality of frequencies and one or more programs at each of the plurality of frequencies;
a program information obtaining unit configured to obtain program information which identifies the program included in the signal that is extracted in the tuner unit; and
an output unit configured to output a signal representing channel information which can be selected for broadcasting,
wherein the channel information includes,
first information which represents that, without identifying the program included in the frequency extracted, the frequency is available, and
second information which represents that, by identifying the program included in the frequency on the basis of the program information obtained in the program information obtaining unit, the frequency is available, and
wherein the first information and the second information are information corresponding to different frequencies of the broadcasting signal, respectively.

20. The receiving apparatus as set forth in claim 19, wherein,
the first information comprises information which represents that the physical channel is available, if the physical channel including a digital broadcasting signal can be extracted in the tuner unit and the program information of the physical channel cannot be obtained by the program information obtaining unit, and
the second information comprises information which represents that one or more programs included in the physical channel are available, if the physical channel including a digital broadcasting signal can be extracted in the tuner unit and the program information of the physical channel can be obtained by the program information obtaining unit.

21. The receiving apparatus as set forth in claim 19, further comprising a memory unit configured to store the channel information, wherein when a physical channel selected from the memory unit includes information representing that, without identifying the program included in the physical channel, the physical channel is available, the program information obtaining unit newly obtains the program information included in the physical channel, and the output unit outputs images of one or more programs included in the physical channel based on the program information obtained.

22. A digital broadcasting receiving method in which channel information of a digital broadcasting is scanned by channel scan and stored, comprising:
selecting a physical channel from a signal received;
judging whether or not the selected physical channel includes a digital broadcasting signal;
judging whether or not program information included in the digital broadcasting signal can be obtained, in case that it is judged that the digital broadcasting signal is included; and
storing in a memory unit that the physical channel includes the digital broadcasting signal, when it is judged that the selected physical channel includes the digital broadcasting signal but the program information included in the digital broadcasting signal cannot be obtained.

23. The digital broadcasting receiving method as set forth in claim 22, further comprising:
displaying that the physical channel includes the digital broadcasting signal, when it is judged that the selected physical channel includes the digital broadcasting signal but the program information included in the digital broadcasting signal cannot be obtained; and
displaying channel information of the physical channel, when it is judged that the selected physical channel includes the digital broadcasting signal and the program information included in the digital broadcasting signal can be obtained.

24. The digital broadcasting receiving method as set forth in claim 22, further comprising, when a physical channel selected from the memory unit includes a signal which was judged to include the digital broadcasting signal but the digital broadcasting signal was judged to contain program information which could not be extracted:
newly obtaining the program information of the physical channel,
storing in the memory unit the newly obtained program information of the channel; and
outputting a program included in the physical channel, based on the newly obtained program information of the physical channel.

25. A receiving circuit for receiving a digital broadcasting signal, comprising:
an input unit to which a signal of a selected physical channel is inputted;
a first judging unit configured to judge whether or not the signal which is inputted by the input unit includes the digital broadcasting signal;
a second judging unit configured to judge whether or not program information included in the digital broadcasting signal can be extracted, when it is judged in the first judging unit that the inputted signal includes the digital broadcasting signal;
a program information obtaining unit configured to extract program information included in the inputted digital broadcasting signal; and
a memory unit configured to store a judgment result in the first judging unit, and to store the program information of the digital broadcasting signal which is obtained by the program information obtaining unit if it is judged in the second judging unit that the program information which is included in the digital broadcasting signal can be extracted.

26. A digital broadcasting receiving method in which channel information of a digital broadcasting is scanned by channel scan, comprising:
scanning a signal to preset one or more physical channels;
displaying that a physical channel includes a digital broadcasting signal if the physical channel includes a digital broadcasting signal but the program information included in the digital broadcasting signal cannot be obtained; and
displaying channel information of a physical channel, if the physical channel includes a digital broadcasting signal and the program information included in the digital broadcasting signal can be obtained.
